(19) United States
(12) Patent Application Publication
(10) Pub. No.: US 2009/0262237 A1
(43) Pub. Date: Oct. 22, 2009

(54) High Deflection Angle CRT Display

(76) Inventor: Richard Hugh Miller, Ephrata, PA (US)

Correspondence Address: Thomson Licensing LLC, P.O. Box 5312, Two Independence Way, PRINCETON, NJ, 08543-5312, US

(21) Appl. No.: 11/990,534

(22) PCT Filed: Jun. 14, 2006
(86) PCT No.: PCT/US2006/023240

§ 371 Date: Feb. 14, 2008

Related U.S. Application Data
(60) Provisional application No. 60/713,106, filed on Aug. 31, 2005.

(51) Int. Cl. H04N 9/22

(52) U.S. Cl. 348/381; 348/E09.018

(57) ABSTRACT

A display has a panel (3) connected to a funnel (5). An electron gun assembly (13) positioned in a neck (4) at a narrow end of the funnel is provided for directing electron beams toward a screen (12) on the panel. The display includes a yoke (14) to scan the beams across the screen, a degauss coil positioned on the funnel for degaussing the display, and a DC canceller coil (72) for counteracting beam displacement caused by North/South magnetic fields. The display can include a means to dynamically correct beam landing errors, additional coils near the wide end of the funnel to further assist in correcting beam landing errors, and a magnetic field sensor (17) to sense ambient magnetic fields and generate signal to appropriate drivers to correct for beam landing errors.

### CROSS-REFERENCE TO RELATED APPLICATIONS

This application claims the benefit under 35 U.S.C. 119(e) of U.S. Provisional Patent Application Ser. No. 60/713,106, filed Aug. 31, 2005, which is incorporated by reference herein in its entirety.

### FIELD OF THE INVENTION

This invention presents ways of operating high deflection angle vertical scan tubes which are subjected to magnetic fields which degrade the color uniformity of images.

### BACKGROUND OF THE INVENTION

An ambient magnetic field in a vicinity of a cathode ray tube (CRT) can affect the color rendition of an image projected on a viewing faceplate of the CRT. The ambient magnetic field is mainly caused by the earth's magnetic field and can be affected by local magnetic fields and magnetic materials in the area. The ambient magnetic field being unidirectional, can be vectorially decomposed into a vertical and a horizontal part, and these components depend on the given geographical location of concern. The effect of the North/South and East/West components of an ambient magnetic field on the electron beams in a CRT with respect to the given CRT coordinate system completely depends on the orientation of the CRT. In a given latitude, the effect of the vertical component on the path of the electron beams of the CRT is relatively constant and will vary as the geographic latitude of the CRT changes. The effect of the horizontal components (which can be North/South and/or East/West oriented with respect to the CRT) on the path of the electron beams of the CRT changes as a function of the orientation of the CRT.

In a conventional CRT that has inline electron guns aligned in a horizontal plane and vertically oriented phosphor stripes, the vertical component of the ambient magnetic field deflects the electron beams horizontally, which affects the register of each of the electron beams on the desired phosphor stripe. The North/South components of the ambient magnetic field causes lateral deflection of the electron beam at the top and bottom of the screen. The East/West component of the ambient magnetic field combined with the internal magnetic shields causes lateral deflection of the electron beam in the corners. Since the vertical component is relatively constant and not affected by the orientation (in a horizontal plane) of the CRT, the CRT can be set to minimize vertical field misregister. Both North/South and East/West orientations of the CRT cause register effects as the CRT is varied in the horizontal plane direction; as such, magnetic shielding could be designed to balance the effect of North/South and East/West orientation and keep the overall effects of the earth's magnetic field to within the tolerance of the system. Such magnetic shielding systems are well known in the art.

Recently, the demand for large aspect ratio CRTs has led to the development of CRTs having inline electron guns aligned in a vertical plane and horizontally oriented phosphor stripes. In these CRTs, the vertical component of the ambient magnetic field combined with the internal magnetic shield causes the electron beams to deflect horizontally along the phosphor lines, which does not significantly affect the register of each of the electron beams on the desired phosphor stripe, especially for high deflection angles in the corners, except for some vertical component in the corners. The horizontal component of the ambient magnetic field causes the electron beams to deflect vertically, which affects the register of each of the electron beams on the desired phosphor stripes. Because the effect of the horizontal component on the path of the electron beams changes dramatically as the orientation of the CRT in the East to West direction is varied, it is significantly more difficult to design adequately balanced shielding for all North, South, East, and West orientations. Additionally, the relationship between the orientation of the CRT and the horizontal component is entirely under the control of the consumer, who will orient the CRT based on personal preference. Further, as the deflection angle of CRTs has increased from 100° through 125° and now to 140°, these tubes have become more sensitive to the detrimental effects of magnetic fields. One source for this increased magnetic sensitivity is the fact that with the increasing deflection angle, there is a direct and corresponding loss in the space available to design an effective internal magnetic shield. Available IMS space inside the glass bulb for a W76 CRT has been reduced from a height (i.e., in Z-axis) of 6.2 in. in a 106° tube to a mere 1.2 in. in a 140° tube.

It is therefore desirable to develop a compensation system that reduces the effect of ambient magnetic fields in CRTs having reduced depth and particularly those CRTs having inline electron guns aligned in a vertical plane and horizontally oriented phosphor stripes.

### SUMMARY OF THE INVENTION

A CRT display device comprises a CRT having a panel connected to a funnel. An electron gun assembly positioned in a neck at a narrow end of the funnel is provided for directing electron beams toward a screen on the panel. The display includes a yoke to scan the electron beams across the screen, a degauss coil positioned on the funnel for degaussing the display device, and a DC canceller coil for counteracting electron beam displacement caused by North/South magnetic fields. The display can further include a means to dynamically correct electron beam landing errors on the screen, additional coils positioned near the wide end of the funnel to further assist in reducing electron beam landing errors, and a magnetic field sensor system capable of sensing the ambient magnetic fields and generating signal to appropriate drivers to correct for electron beam landing errors caused by the ambient magnetic field.

### BRIEF DESCRIPTION OF THE DRAWINGS

FIG. 1 is a cross-section of the display according to the invention.

FIG. 2 is a schematic block diagram of the system according to the invention.

FIG. 3 a schematic illustration of a dipole field utilized in the invention.

FIG. 4 a depiction of a misconvergence pattern on the screen.

FIG. 5 is a schematic description of a quadrupole field that is utilized in the invention.

FIG. 6 is another quadrupole field configuration that is utilized in an embodiment of the invention.

FIG. 7 is a diagram depicting a CRT display screen subject to image distortion.

FIG. 8 shows the application of the video correction system used to correct distortions in the display.

FIG. 9 is a characteristic graph for a polyphase filter within the video correction system.

FIG. 10 shows the use of a degauss coil according the invention in plan view.

FIG. 11 shows the use of a DC canceller coil according the invention in plan view.

FIG. 12 shows the use of another DC canceller coil according the invention in plan view.

FIG. 13 shows the use of corner and axial coils according the invention in plan view.

FIG. 14 shows the use of corner and axial coils in combination with a DC canceller coil and a degauss coil according the invention in plan view.

FIG. 15 shows the use of a DC canceller coil and a degauss coil according the invention in plan view.

### DESCRIPTION OF THE INVENTION

This invention allows high deflection angle CRTs to operate with good performance in a wide variety of magnetic fields.

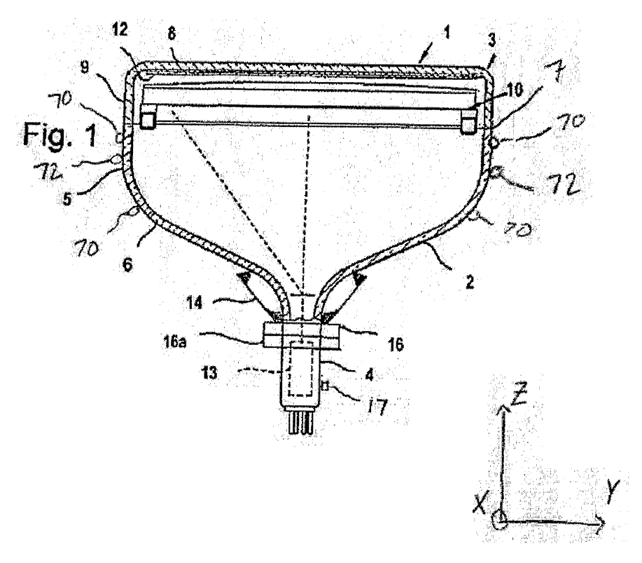

FIG. 1 shows a cathode ray tube (CRT) 1, for example a W76 wide screen tube having a glass envelope 2 comprising a rectangular faceplate panel 3 and a tubular neck 4 connected by a funnel 5. The funnel 5 has an internal conductive coating (not shown) that extends from an anode button 6 toward the faceplate panel 3 and to the neck 4. The faceplate panel 3 comprises a viewing faceplate 8 and a peripheral flange or sidewall 9, which is sealed to the funnel 5 by a glass frit 7. A three-color phosphor screen 12 having a plurality of alternating phosphor stripes is carried by the inner surface of the faceplate panel 3. The screen 12 is a line screen with the phosphor lines arranged in triads, each of the triads including a phosphor line of each of the three colors. A mask assembly 10 is removably mounted in predetermined spaced relation to the screen 12. An electron gun 13, shown schematically by dashed lines in FIG. 1, is centrally mounted within the neck 4 to generate and direct three inline electron beams, a center beam and two side or outer beams, along convergent paths through the tension mask frame assembly 10 to the screen 12. The electron gun 13 can consist of three guns being vertically oriented, which direct an electron beam for each of three colors, red, green and blue. The red, green and blue guns are arranged in a linear array extending parallel to the minor axis of the screen 12. The phosphor lines of the screen 12 are accordingly arranged in triads extending generally parallel to the major axis of the screen 12. Likewise, the mask of the mask assembly 10 has a multiplicity of elongated slits extending generally parallel to the major axis of the screen 12. It should be understood by those reasonably skilled in the art that various types of tension or shadow mask assemblies which are well known in the art may be utilized. Further, the invention also has applicability for electron guns systems where the electron guns are oriented horizontally. This is particularly applicable when the ambient environment has magnetic contributions including the Earth's magnetic field and other situation where the local magnetic environment causes register shifting analogous to the register shifting experienced in a system with vertically oriented electron guns due to the horizontal field East to West orientation.

The CRT 1 is designed to be used with an external magnetic deflection system having a yoke 14 shown in the neighborhood of the funnel-to-neck junction. When activated, the yoke 14 subjects the three beams to magnetic fields which cause the beams to scan vertically and horizontally in a rectangular raster over the screen 12.

One feature of the invention is the application of one purity correction means which optionally involves a magnetic field sensor 17 positioned near the CRT 1. Although the magnetic field sensor 17 is shown in the embodiment of FIG. 1 as being located near the neck area, it can be attached to the circuit board of the display. For example, based on ease of manufacturability, the magnetic field sensor 17 may be positioned within a cabinet or enclosure which houses the CRT 1. Magnetic field sensor 17 may be, for example, a Hall effect sensor which is capable of detecting magnetic fields in a given axis. It should be understood by those reasonably skilled in the art that the magnetic field sensor 17 may be a single sensor capable of detecting magnetic fields in three axes or may alternatively be three separate sensors, one each for detecting magnetic fields along each major axis. The magnetic field sensor 17 outputs an electrical signal proportional to the ambient magnetic field incident thereon in a given direction. The magnetic field sensor 17, therefore, measures the ambient magnetic field environment of the CRT and its output changes as the CRT is moved or relocated. When the horizontal component of the ambient magnetic field is changed (e.g., East to West), there is a deflection of the beams vertically causing a register shift of the beam landing on the horizontal phosphor stripes. This register shift may degrade color purity.

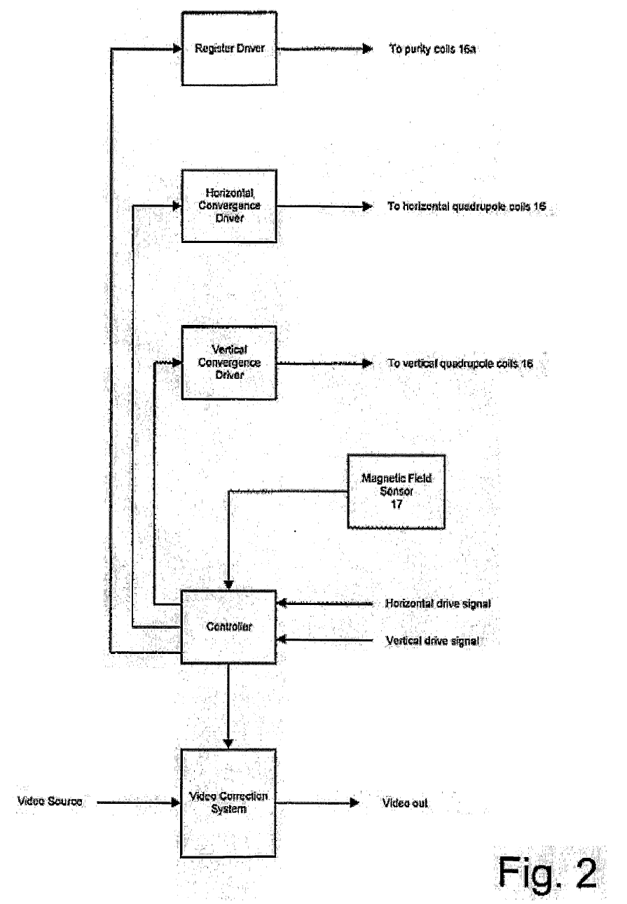

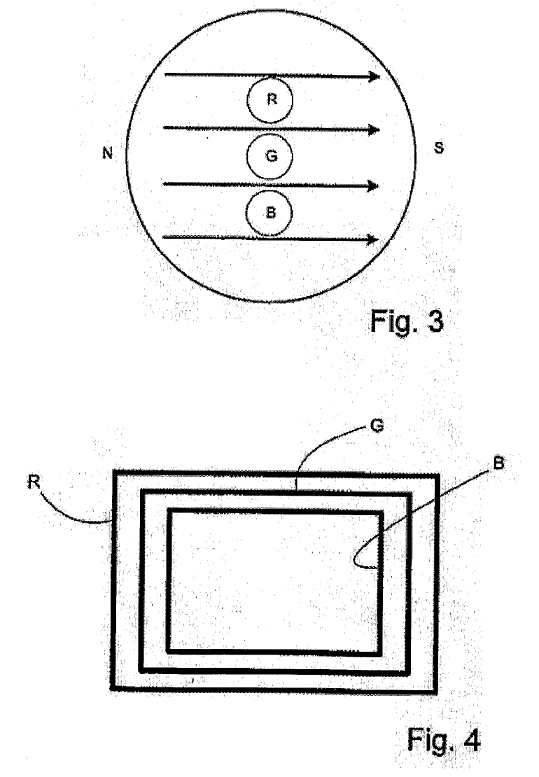

The output signal of the magnetic field sensor 17 is fed into a controller as shown in FIG. 2. The controller dynamically drives a set of register correction coils 16a preferably mounted in the neck region as shown in FIG. 1. The controller also drives a video correction system as shown in FIG. 2. It should be understood by those skilled in the art that the register correction coils 16a may also be referred to as purity correction coils. The register correction coils 16a apply a relatively uniform field across the three beams, as shown schematically in FIG. 3, such that the three beams are uniformly deflected in the direction of the plane of the beams. This deflection moves each beam register normal to the phosphor stripes on the screen 12 so that it can be centered on the respective phosphor stripe. This purity correction, however, causes the beams to shift or become misaligned within the yoke 14 resulting in misconvergence such as depicted in FIG. 4. Here it can be seen that the register correction and resultant beam misalignment within the yoke 14 causes an inward shift or an outward shift of the outer beams, specifically in this example, inward shift of the blue beam and outward shift of the red beam.

The yoke 14 and yoke effects will now be described in greater detail with applicability to the system with vertically oriented electron guns. The yoke 14 is positioned in the neighborhood of the funnel-to-neck junction as shown in FIG. 1 and, in this embodiment, is wound so as to apply a horizontal deflection yoke field which is substantially barrel shaped and a vertical deflection yoke field which is substantially pincushion shaped. The vertical pincushion shaped yoke field is generated by a first deflection coil system being wound on the yoke. The horizontal barrel shaped yoke field is generated by a second deflection coil system also being wound on the yoke such that it is electrically insulated from the first deflection coil system. Winding of the deflection coil systems is accomplished by known techniques. The yoke fields affect beam convergence and spot shape. These fields are generally adjusted to achieve self-convergence of the beams. Instead of adjusting for self-convergence, in the invention, the horizontal barrel field shape is adjusted, for example reduced, to give an optimized spot shape at the sides of the screen. The barrel shape of the field is reduced until an optimized nearly round spot shape is achieved at the 3/9 and corner screen locations. This field shape adjustment, resulting in improved spot shape, compromises self convergence causing misconvergence at certain locations on the screen. Specifically, the beams are overconverged at the sides. Overconvergence as used here describes a condition where the red and blue beams have crossed over each other prior to landing on the screen.

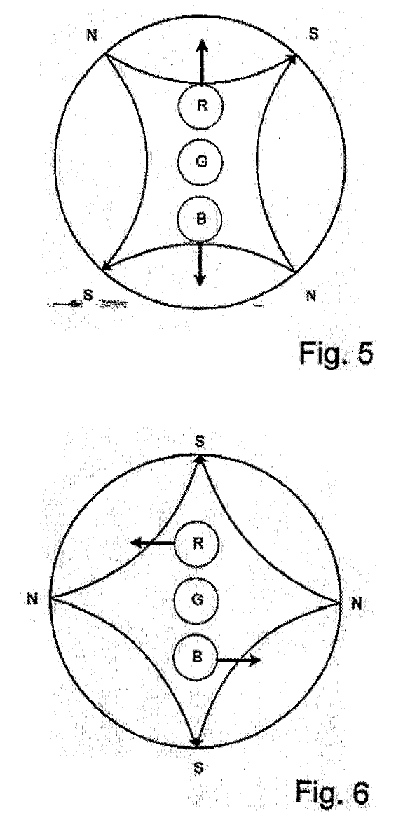

Correction of misconvergence that resulted from both the register correction and the yoke effects described above is achieved by addition of quadrupole coils 16 schematically shown in FIG. 1 and/or the addition of video correction as shown in FIG. 2. In short, the quadrupole coils 16 and/or video correction can be used to correct misconvergence caused by register correction coils 16a and other sources. Misconvergence from the yoke effect at locations along the screen 12 can be dynamically corrected by quadrupole coils 16 located on the gun side of the yoke 14. Four or more quadrupole coils 16 are fixed to the yoke 14 or may alternatively be applied to the neck (FIG. 1) and each have four poles oriented at approximately 90° angles relative to each other as is know in the art. (The poles and influence of the quadupole coils are represented in FIGS. 5 an 6.) The quadrupole coils 16 include a first vertical set of quadrupole coils and a second horizontal set of quadrupole coils. In the vertical set of quadrupole coils, adjacent poles are of alternating polarity and the orientation of the poles is at 45° from the tube axes so that the resultant magnetic field moves the outer (red and blue) beams in a vertical direction as shown by the arrows in FIG. 5 to provide correction for the misconvergence. In the horizontal set of quadrupole coils (FIG. 6), adjacent poles are of alternating polarity and are orientated on the tube axes so that the resultant magnetic field moves the outer (red and blue) beams in a horizontal direction as shown by the arrows in FIG. 6 to provide correction for the misconvergence. Both sets of quadrupole coils 16 are located behind the yoke 14 such that they are approximately at or near the dynamic astigmatism point of the guns 13. The quadrupole coils 16 are dynamically controlled to create a correction field for adjusting miscovergence at locations on the screen. The quadrupole coils 16, in this embodiment are driven in synchronism with the deflection. The magnitude of the quadrupole driving waveform is selected to correct the overconvergence caused by the yoke field described above. In this embodiment the waveform is approximately parabolic in shape. The guns 13 in the embodiments with quadrupole coils have electrostatic dynamic focus (or astigmatism) correction in order to achieve optimum focus in both the horizontal and vertical directions on each of the three beams. This electrostatic dynamic astigmatism correction is done separately on each beam and allows correction of horizontal to vertical focus voltage differences without affecting convergence. Although the quadrupole coils 16 also effect beam focus, their location near the dynamic astigmatism point of the gun allows this effect to be corrected by adjusting the electrostatic dynamic astigmatism voltage of the gun such that the combination does not affect the resultant spot shape. This results in the favorable effect of being able to correct misconvergence at selected locations on the screen without affecting the spot shape. This allows the spot shape to be optimized by the yoke field design and any resultant misconvergence to be corrected by the dynamically driven quadrupole coils 16.

Color purity correction is accomplished by dynamically adjusting register correction coils 16a preferably mounted in the neck region. The register correction coils 16a apply a relatively uniform field across the three beams such that the three beams are uniformly deflected in the direction of the plane of the beams. This deflection moves each beam register normal to the phosphor stripes so that it can be centered on the respective phosphor stripe. Such coils could be integrated with the quadrupole coils 16 or, alternatively, integrated with the yoke 14 and yet again alternatively, located independently on the neck in the general region between the quadrupole coils 16 and yoke 14. Neck mounted register correction coils 16a cause beam displacements in addition to beam angle changes. The combination of these changes to the beam paths result in simultaneous register and convergence changes as these coils are activated. Therefore, dynamic programming of the quadrupole coils 16 in appropriate synchronization with the register correcting coils 16a is required in order to simultaneously maintain purity and convergence.

As shown in FIG. 2, a dynamic waveform generating controller is utilized to generate the required waveforms for convergence and register corrections. The fundamental inputs to the controller are the magnetic field data provided by a magnetic field sensor or sensors and timing signals provided by the horizontal and vertical drive signals. The controller contains appropriate memory and programming functions such that the dynamic waveforms can be set up according to the local magnetic configuration. The controller outputs signals to a video correction system, a register driver, a horizontal convergence driver and a vertical convergence driver. The video correction system is controlled by the controller to apply a distortion to a video source signal which passes to a video output and ultimately to electron gun 13 as will be described below. The register driver receives input from the controller and sends an output to drive register correction coils 16a of FIG. 1 accordingly. The horizontal convergence driver likewise receives an input signal from the controller to drive quadrupole coils 16 of FIG. 1 which affect horizontal convergence. Likewise, the vertical convergence driver receives input from the controller and sends an output signal to drive quadrupole coils 16 of FIG. 1 which affect vertical convergence. Other suitable types of multipole coils could be substituted for the quadrupole coils. This one purity correction method, however, is not substantial enough on its own when very large corrections are needed (i.e. a need for high amplitude purity corrections).

A facet of this invention includes the use video correction in conjunction with purity correction. Video correction can be incorporated into the various other embodiments of the invention in order to assist in obtaining proper raster geometry when ambient magnet conditions would either distort raster geometry. In video correction, digital video signal information is mapped to the appropriate scan location to correct convergence and geometry. This video mapping does not affect the spot shape and is an effective tool for small corrections. Video correction to improve convergence is attractive because it may obviate the need for multipole correction, for example, by quadrupole coils and can also correct residual raster geometry errors. (Raster geometry errors can includes deviations from a desired raster shape.) The elimination of the quadrupole coils is particularly beneficial, because it reduces the cost of the novel CRT. Although the controller can be configured by design to drive the coils and/or the video correction system simultaneously, as shown in one embodiment of the invention, including the use of both the quadrupole coils and digital video correction to improve convergence, it should be understood that the controller may be configured to drive only the video correction system, thus eliminating the need for quadrupole coil correction as described above. However, video correction can still work in conjunction with quadupole coils.

In general, CRT displays exhibit raster distortions. The most common raster distortions pertain to geometric errors and to convergence errors. Both geometric and convergence errors are position errors in the scanned positions of the beams as the raster is drawn on the screen. Convergence errors occur when, in a CRT display, the Red, Green and Blue rasters are imperfectly aligned such that, for example, over some portion of the image the Red sub-image is displaced left with respect to the Green sub-image and the Blue sub-image is displaced to the right of the Green sub-image. Convergence errors of this type can occur in any direction and anywhere in the displayed image. Geometry errors occur when the actual beam locations during the scan deviate from their intended locations and can be detected when one applies an input signal corresponding to a grid designed to have a uniform field of squares is displayed as having non-uniform field of squares. Also, with any practical embodiment of the known color CRT, both convergence and geometric errors become readily visible even if the center region is perfectly aligned during the original manufacture of the CRT, assuming that the deflection signals applied to the deflection coils are linear ramps. Utilizing traditional, well known in the art, analog circuit techniques to compensate for such distortions, the deflection signals can be modified from linear ramps to more complex wave shapes. Also, the details of the yoke design can be adjusted such that convergence errors and geometry errors are reduced. As the deflection angle is increased beyond 110°, such traditional methods of geometry and convergence corrections become more and more difficult. Furthermore, with the availability of low cost digital signal processing techniques, it is possible and economically feasible to partially replace or supplement the traditional analog correction methods with digital signal processing.

Video correction involves mathematically operating on an input signal and then processing it in a manner of inverse distortion. With reference to the example given above for convergence errors, the inverse distortion to be performed by video correction is to move the Red sub-image right by the same amount with respect to the Green sub-image as the final CRT distortion will move it to the left and similarly move the Blue sub-image to the left.

The video correction system in this invention works in conjunction with the magnetic field sensor readings of the magnetic field sensor 17. (As such, video correction can be used in any of the embodiments of the inventions to assist in correcting misconvergence or geometry errors of the subimages or both.) Essentially video correction information based on predetermined magnetic field configurations is stored in a memory. This memory can be created, for example, during the display system manufacture by simulating a plurality of local earth magnetic field conditions relative to CRT system orientation. For each such simulation condition, optimized video correction parameters are determined. These parameters are stored in local memory. During tube operation, the field sensor 17 measures the local earth magnetic conditions and relays the measurements in the form of an input signal to the controller, which can include the memory. Based on the information from the field sensor 17, register and convergence are optimized by the corresponding coil systems. Further, based on the measured magnetic field information, the closest match to one of a number of original setup conditions is determined and the appropriate video correction parameters stored in memory are utilized. A further refinement may include interpolation of the prestored values so that instead of a match to exact prestored values, interpolated video correction parameters can be used to better optimize the convergence and residual raster geometry.

The CRT according to the invention can also include the application of beam scan velocity modulation (BSVM) in the fast vertical scan direction. BSVM constitutes a sharpness enhancement method that involves local changes in the scan velocity of the electron beam based on brightness transitions in the video signal inputs. A video correction element or digital enhancement unit could provide a suitable BSVM signal.

Regarding video correction, it could be performed by a gate array element and a video correction element. Video correction can occur by first determining the geometric offset resulting from mis-convergence or raster distortion, and establishing the necessary horizontal and vertical displacement (i.e., Δx and Δy) needed to correct the misconvergence offset or raster distortion. The video then undergoes displacement by Δx and Δy to correct for such misconvergence.

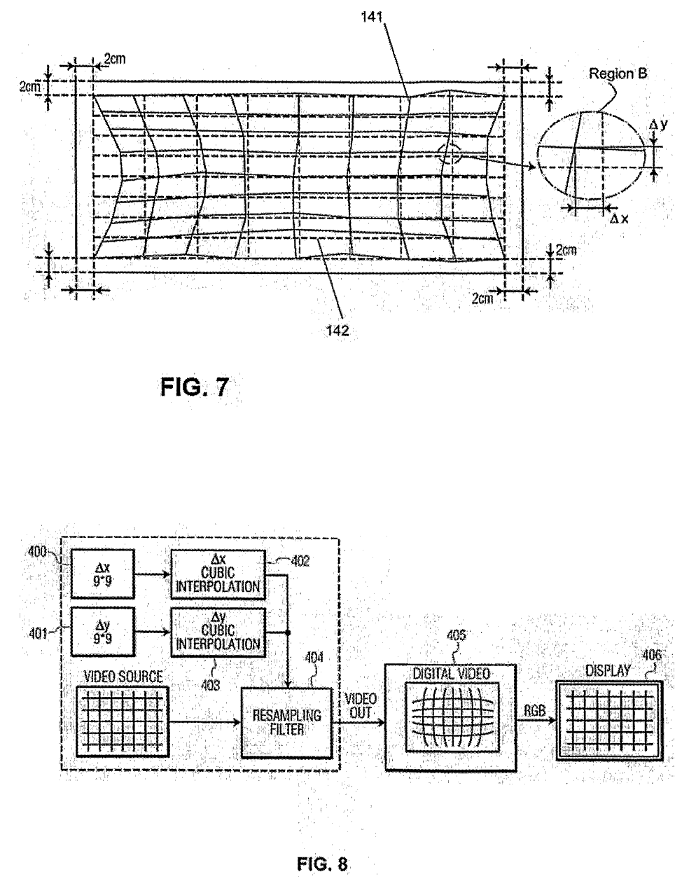

To better understand the process by which such video correction occurs, refer to FIG. 7, which depicts an example of image distortion appearing on a CRT screen. Within the encircled area, the image appears distorted by the amounts Δx and Δy (shown as ΔVx and ΔVy in the FIG. 7). Note that the distortion over the image is not homogeneous and differs for each color. (The solid line pattern 141 shown in FIG. 7 can be one raster shape for one of the sub-images and dotted line pattern 142 can be the ideal raster shape for all three color sub-images.)

FIG. 8 provides a general overview of video correction for distortion in accordance with the present principles and adds further detail to the video correction system described above with reference to FIG. 2. First, the controller determines the x and y offsets (Δx and Δy) for the measured ambient magnetic field, typically with a grid of 9×9 or a 5×5 points spaced over the entire image, yielding Δx and Δy offset matrices 400 and 401. The Δx and Δy offset matrices undergo interpolation, via elements 402 and 403 in FIG. 8. In practice, the elements 402 and 403 can take the form of a programmed processor, application specific integrated circuit, field programmable gate array or digital signal process as an example. A re-sampling filter 404 re-samples video from an incoming video source, such as the progressive RGB(p) signals and produces a video out signal to yield a video image 405 that is distorted by an amount inverse to the distortion that arises from the geometric raster distortion of each color. It should be understood that the video out signal comprises an inverse distortion of the red sub-image, and inverse distortion of the green sub-image and an inverse distortion of the blue sub-image. Thus, the inverse distortion created by video correction cancels the original distortion, yielding a substantially distortion free-image 406. As discussed, the horizontal Δx and vertical Δy displacements are measured or computed on a 9×9 grid. Interpolation of Δx and Δy samples becomes necessary to know the displacement at each point of the re-sampled image typically by the well known two dimensional cubic interpolation.

The result of the interpolation is a distortion vector comprising integer and non-integer components in both the x and y direction. The re-sampling filter 404 consists of a simple remapping of the pixels for the integer component of the distortion vector and of a polyphase filter for the non-integer component. The remapping is conveniently accomplished by reading out a video source memory with adjusted addresses, whereas the integer part of the above interpolation, typically cubic interpolation, is used for the address adjustment.

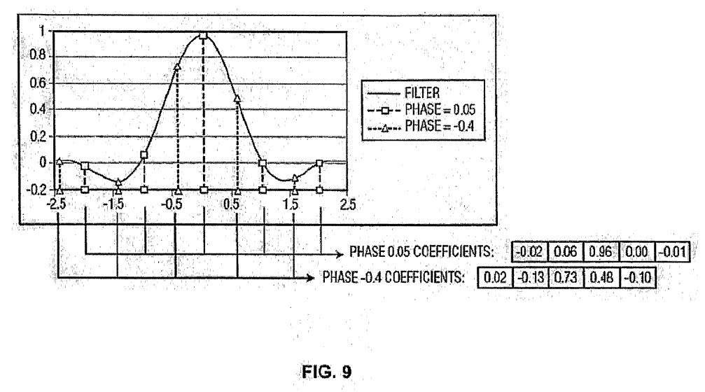

For performing the non-integer component of the re-sampling operation, filter 404 of FIG. 8 can take the form of a five tap polyphase filter as described in graph of FIG. 9. The graph of FIG. 9 shows coefficient values on its y-axis and tap values on its x-axis. The polyphase filter adapts its coefficients to the non-integer shift between the original and the final pixels. The non-integer component of the interpolation can assume values between −0.5 and +0.5, corresponding to interpolated pixel positions +−0.5 sample spaces from the closest integer value. In FIG. 9 the computed five tap-weights are shown for two non-integer interpolated pixels. The non-integer components computed from the interpolation, shown here are +0.05 and −0.4 pixels from the closest integer position, these are referred to as Phase=0.05 and Phase=−0.4 in FIG. 9 respectively. The five element tables associated with each indicated Phase gives the weights for the filter tap summations, indicated in FIG. 9 as coefficients. Typically look-up tables are used to store the coefficients for a finite number of non-integer interpolated values. A common approach is to store the coefficients for 64 discreet phases and select the phase closest to the interpolated value.

Regarding color purity, a method of obtaining color purity includes the automatic sensing of the magnetic fields, but alone may not provide sufficient correction. Degaussing coils (e.g. twisted loop) can be utilized, but requires a sizeable internal magnetic shield to provide sufficient correction if significant misregister occurs. Also canceller coils can be used and can particulary be helpful for corner correction capability.

This invention identifies the combination of more than one of these other options as the practical method for regaining acceptable magnetic performance from tubes with very high deflection angles, especially for CRT having transposed scanning (i.e. vertically oriented electron guns and horizontal phosphor stripes). (In transposed scanning systems the fast scan rate is in the vertical dimension and the low scan rate is in the horizontal dimension.) There are three main components of a magnetic field effects correction system for such a CRT:

1. Degauss coils 70 (e.g. twisted-loop) (FIG. 10)

2. Active correction.

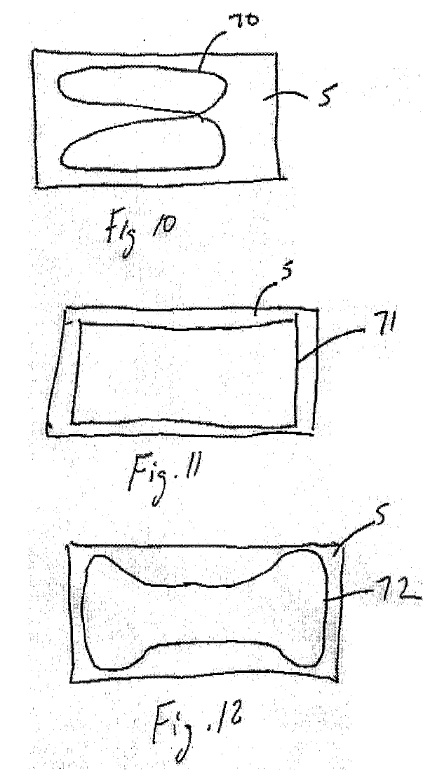

3. DC Canceller Coil 71, 72 to the North/South effects [FIG. 11 or 12]

Along with two optional components:

4. Automatic sensing of the magnetic fields (e.g. with magnetic field sensor 17 in FIG. 1).

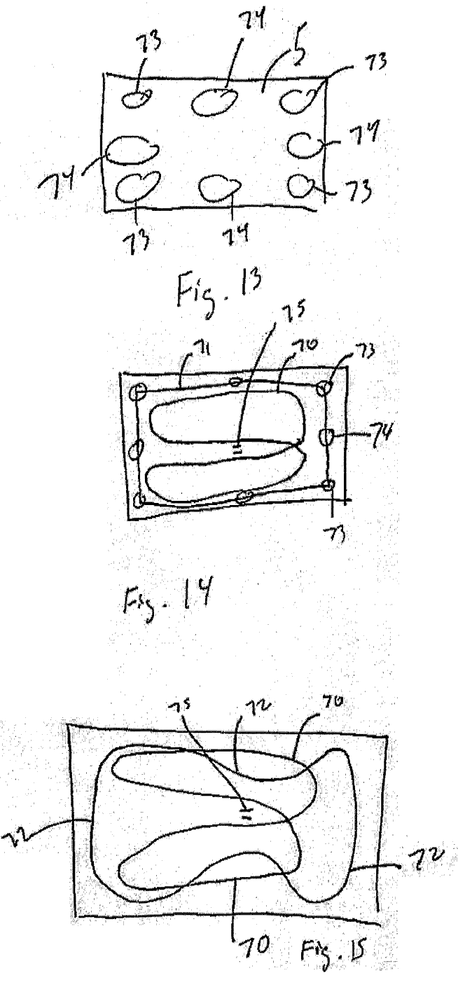

5. Individual coils for corner optimization (i.e. corner coils 73 and axial coils 74 in FIGS. 13 and 14).

By adding a canceller coil to the combination of a twisted-loop degauss coil 70 and the active correction concept, the total register correction required by the very-high-deflection-angle tubes can be implemented without the problems caused by the large register corrections required without the canceller coil.

This approach will also allow the internal magnetic shield to be designed so that the corrections for the E/W magnetic field are optimized since the canceller coil will handle the N/S compensation.

The above correction would require some user input to properly set the amplitude of the current in the canceller coils, but if optional component 17 were implemented, then the current level would be handled automatically by the sensing circuit and the processing of that data to create the proper current in the canceller coil.

For some further improvements in performance, additional coils, which are DC, (corner coils 73, axial coil 74) as shown in FIG. 13 could be added to the tube at special locations (e.g. corners, axis ends, etc). The current amplitude in these coils could be set during the production of the TV, by specific inputs. A further enhancement could be implemented by combining the above inputs with the automatic field sensing so the current in the additional coils could be modified based on the magnetic field the tube is operated in. For example, FIG. 14 shows an embodiment where there is a combination of coils which work with automatic field sensing, which includes register correction means 75 near the neck 4. FIG. 15 shows an embodiment where there is a combination of coils which work with automatic field sensing, which includes register correction means 75 (which can be a dynamic dipole) near the neck 4.

The advantages of the invention can be used in CRTs of any deflection angle with any arrangement of the electron guns. However, CRTs having deflection angles of 100° to 125° with vertically oriented electron guns are particularly vulnerable to ambient magnetic environments, and as such, these displays will perform better in terms of convergence and purity when employing the embodiments disclosed. Further, those skilled in the art will appreciate that CRTs with deflections angles greater than 125° such as 140° or greater (especially with vertically oriented electron guns), would even more greatly benefit from the implementation of the embodiments described, because the spacial constraints at such deflection angles leave very little room to implement any internal magnetic shield. As such, a magnetic shield on its own coupled standard convergence and purity correction technology will not suffice to ensure adequate CRT performance at such large deflection angles.

An advantage of the invention is that it effectively corrects for sample-to-sample variability that can occur in CRT manufacturing and variability that can occur from location-to-location regarding purity and/or convergence within given CRTs. The variability can include variability in CRTs, yokes, electron guns and setup conditions in the CRT factory. The invention is more effective than the level of correction that the standard static corrections typically used in the CRT industry can offer for given tubes, because the invention allows for one level of correction commensurate with a deficiency in one area and another level of correction commensurate with some other level of deficiency in another area).

1. A display device, comprising:
a cathode ray tube having a panel connected to a funnel,
an electron gun assembly for directing electron beams toward a screen on the panel, the electron gun assembly being positioned in a neck at a narrow end of the funnel,
a yoke for scanning the electron beams across the screen at a fast vertical scan rate, the yoke being positioned near the narrow end of the funnel,
a degauss coil positioned on the funnel for degaussing the display device, and
a DC canceller coil for counteracting electron beam displacement caused by North/South magnetic fields.

2. The display device according to claim 1, further comprising a means for dynamically correcting electron beam landing errors on the screen.

3. The display device according to claim 2, wherein the correcting means comprises a register correction device positioned on the neck to cause simultaneous shifting of the beams.

4. The display device according to claim 2, wherein the correcting means also comprises a multipole device positioned on the neck to correct for misconvergence caused by the register correction device.

5. The display device according to claim 1, wherein the deflection angle of the display is 100° to 125°.

6. The display device according to claim 1, wherein the deflection angle of the display is greater than 125°.

7. A display device, comprising:
an envelope including a faceplate panel and a neck connected by a funnel, the faceplate panel having a screen, said screen having luminescent lines horizontally oriented;
an electron gun assembly positioned in the neck for directing electron beams toward the screen,
a yoke positioned near the narrow end of the funnel for scanning the electron beams across the screen at a fast vertical scan rate,
a degauss coil positioned on the funnel for degaussing the display device,
a means for dynamically correcting electron beam landing errors on the screen,
a DC canceller coils for counteracting electron beam displacement caused by North/South magnetic fields, and
additional coils positioned near the wide end of the funnel to further assist in electron beam landing errors,
a magnetic field sensor system capable of sensing the ambient magnetic field and generating signal to appropriate drivers to correct for electron beams landings errors cause by the ambient magnetic field.

8. The display device according to claim 7, wherein the correcting means comprises a register correction device positioned on the neck to cause simultaneous shifting of the beams.

9. The display device according to claim 8, wherein the correcting means also comprises a multipole device positioned on the neck to correct for misconvergence caused by the register correction device.

10. The display device according to claim 7, wherein the additional coils are positioned in the corners.

11. The display device according to claim 7, wherein the additional coils are positioned in the axial locations.

12. The display device according to claim 7, wherein the deflection angle of the display is 100° to 125°.

13. The display device according to claim 7, wherein the deflection angle of the display is greater than 125°.

14. The display device according to claim 8, wherein the correcting means also comprises a video correction.

15. The display device according to claim 9, wherein the correcting means also comprises a video correction.
